(19) United States
(12) Patent Application Publication
(10) Pub. No.: US 2006/0261563 A1
(43) Pub. Date: Nov. 23, 2006

(54) Self-locking drill chuck

(76) Inventors: Guimo Yang, Wendeng Shandong (CN); Xingda Tan, Wendeng Shandong (CN); Ping Guo, Wendeng Shandong (CN)

Correspondence Address: BRINKS HOFER GILSON & LIONE, P.O. BOX 10395, CHICAGO, IL, 60610, US

(21) Appl. No.: 10/550,637

(22) PCT Filed: Mar. 25, 2004
(86) PCT No.: PCT/US04/09232

§ 371 Date: Jul. 13, 2006

(30) Foreign Application Priority Data
Mar. 25, 2003 (CN) 03216881.0

(51) Int. Cl. B23B 31/12

(52) U.S. Cl. 279/62

(57) ABSTRACT

A self-locking chuck having a rotational sleeve with at least one protruding stopper to guide at least one pawl provided on a nut sleeve. The pawl will engage teeth provided on the periphery of a gear wheel that is fixed to the rear portion of the chuck body.

This application claims priority to Chinese patent application serial number 03216881.0 filed Mar. 25, 2003, the entire contents of which are incorporated herein by reference.

### BACKGROUND OF THE INVENTION

The present invention relates to a drill tool chuck fixture and more particularly to a self-locking drill chuck.

Known drill chucks generally include a chuck body, gripping jaws, ring nut, nut sleeve, bearing, front sleeve, rear sleeve, etc. The gripping jaws are fitted to the three corresponding inclined holes on the chuck body. The ring nut is fitted inside the ring nut groove of the chuck body and the thread of the ring nut and gripping jaw combine to form a screw gear. The nut sleeve and the nut are generally fixed to each other. The front sleeve is fitted to the nut or the nut sleeve. The rear sleeve is fitted to the chuck body permanently or otherwise. At the rear part of the chuck body there is a threaded hole or a taper hole. The threaded hole of the chuck body is connected to the shaft of a power drill, so that when the drill shaft turns, it will drive the chuck jaws to turn together as well as the drill tool clamped by the jaws.

When in use, the front sleeve is twisted by hand and the front sleeve causes the ring nut to turn via the ring nut housing, and via its thread, the ring nut causes the gripping jaw to move back and forth in the inclined holes in the chuck body, thereby causing the jaws to close to tighten the drill tool. Unfortunately, these known chucks easily loosen when subjected to vibrations or impacts.

To solve this problem, it has been suggested to provide self-locking chucks. One problem with such self-locking chucks is that the structure is complicated and thus difficult for mass manufacture.

The invention is intended to overcome the above limitations and to provide a self-locking chuck that has a reasonable structure, possesses high work efficiency, and convenience.

### SUMMARY

The present invention therefore provides a self-locking drill chuck. The self-locking drill chuck includes a drill body, three gripping jaws, a ring nut, a housing, and an axial hole at the back of the drill body to link to the power shaft of the powering tool. The three gripping jaws are fitted to the three commensurate inclined holes on the drill body. The ring nut engages the gripping jaws fitted on the inclined holes of the drill body. There is a rotating serrated ring between the thrust face of the drill body and the ring nut. There is a rolling element between the serrated ring and the ring nut. A ring shaped drive piece is fixed to the outer link of the ring nut and the ring-shaped drive piece is connected to the outer housing.

The front sleeve carries a nut sleeve to turn through a rotational sleeve, which is disposed between the front sleeve and the nut sleeve. The nut sleeve has at least one pawl. The rotational sleeve has at least one aperture to define a protruding stopper that will guide the pawl of the nut sleeve to move inward or outward. A gear wheel having a plurality of spaced apart teeth is provided around the chuck body. The pawl corresponds with the teeth of the gear wheel. When the pawl is pushed inwards, it will fit into the teeth thus the chuck will be self-locking.

### BRIEF DESCRIPTION OF THE DRAWINGS

FIG. 1 is a structural representation of the present invention.

FIG. 2 is a cross-sectional view of the present invention.

### DESCRIPTION

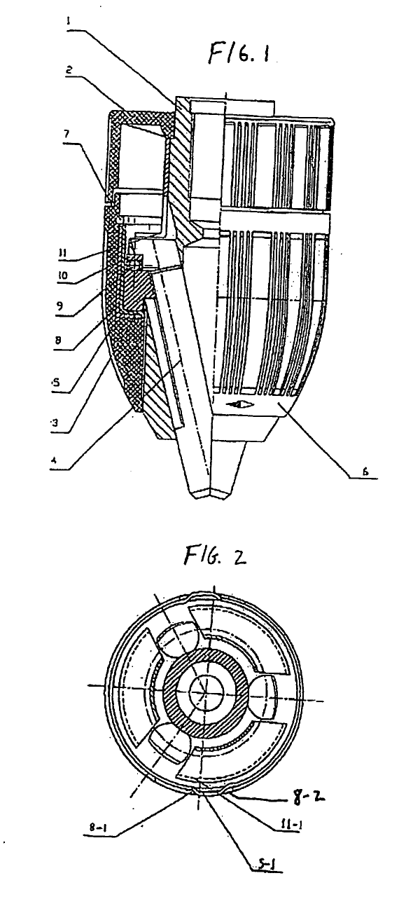

As shown in FIG. 1 and FIG. 2, the self-locking chuck of the present invention includes a chuck body 1, a rear sleeve 2, a nut 3; jaws 4, a nut sleeve 5, a front sleeve 6, a spring 7, a rotational sleeve 8, a bearing 9, and a spacer 10. The ring nut 3 is fitted inside the ring nut groove of the drill body 1 and the thread of the ring nut 3 and the three gripping jaws 4 combine to form a screw gear. The nut sleeve 5 is fitted to the ring nut 3, desirably permanently. The nut sleeve 5 and the ring nut 3 are fixed to each other, desirably permanently. The rear sleeve 2 is fitted to the chuck body 1, desirably permanently. At the rear part of the chuck body 1 there is a threaded hole or a taper hole. The above structure and the relationship of the connected parts are existing technology thus further details are not necessary.

As shown in FIG. 1 and FIG. 2, a rotational sleeve 8 is disposed between the front sleeve 6 and the nut sleeve 5. The rotational sleeve 8 is mounted onto nut sleeve 5. Through the rotational sleeve 8, the front sleeve 6 carries the nut sleeve 5 to turn, either to loosen or tighten the jaws 4, depending on the direction turned.

On the rotational sleeve 8 there is at least one and desirably two apertures 8-2 that define a protruding stopper 8-1. The nut sleeve 5 has at least one pawl and desirably two pawls 5-1. A gear wheel 11 is fixed to the rear part of the body 1. The gear wheel 11 has teeth 11-1. When tightening or loosening the chuck, through rotation of the rotational sleeve 8, the front sleeve 6 carries the nut sleeve 5 to turn accordingly. As a result, the stopper 8-1 of the rotational sleeve 8 will guide the pawl 5-1 of the nut sleeve 5 to move inwards or outwards. The pawl 5-1 corresponds with the teeth 11-1 of the gear wheel 11. In other words, the teeth 11-1 of the gear wheel 11 are spaced apart to such that the pawl 5-1 can engage the space between the teeth 11-1. When the pawl 5-1 is pushed inward, it will fit into the teeth 11-1 thus the chuck will be self-locked.

As seen from FIG. 2, the nut sleeve 5 desirably has two identical pawls 5-1 on either side. Each pawl 5-1 has a v-shaped bend and is slightly convex. Through rotation of the rotational sleeve 8, the front sleeve 6 carries the nut sleeve 5 to turn accordingly. The rotational sleeve 8, however, can also turn relative to the nut sleeve 5. When the rotational sleeve 8 turns relative to the nut sleeve 5, the pawl 5-1 will be guided through the stoppers 8-1 of the rotational sleeve 8 to move inwards or outwards. When the pawls 5-1 are pushed inwards, it will fit into the teeth 11-1 thus will be self-locked.

In other words, the rotational sleeve 8 has at least one aperture 8-2 which defines a protruding stopper 8-1. Desirably, the rotational sleeve 8 has two apertures 8-2, which may be provided opposite each other. When the front sleeve 6 is rotated, the protruding stopper 8-1 contacts a portion of the pawl 5-1 and the nut sleeve 5 is rotated until the jaws 4 are tightened onto the workpiece. Thereafter, the continued rotation of the front sleeve 6 and thus the rotational sleeve 8 causes the protruding stopper 8-1 to urge pawl 5-1 into locking engagement with the teeth 11-1 provided on the gear wheel.

On the other hand, when it is desired to loosen the engagement of the jaws 4 from the workpiece, the front sleeve 6 is rotated in a loosening direction (i.e., opposite the direction of the tightening direction). When the aperture 8-2 is aligned with the pawl 5-1, the pawl 5-1 will move into the aperture and out of engagement of the teeth.

Advantageously, therefore, the self-locking chuck of the present invention will not easily loosen due to vibration or impacting. Of course, it should be understood that a wide range of changes and modifications could be made to the embodiments described above. It is therefore intended that the foregoing detailed description be regarded as illustrative rather than limiting, and that it be understood that it is the following claims, including all equivalents, that are intended to define the spirit and scope of this invention.

What is claimed:

1. A self-locking drill chuck that includes a chuck body, at least one gripping jaw, a ring nut, a nut sleeve, a front sleeve, and a rear sleeve, comprising:
a. a rotational sleeve disposed between the front sleeve and the nut sleeve, the rotational sleeve having at least one protruding stopper;
b. a gear wheel fixed to a portion of the chuck body and having a plurality of spaced teeth about a periphery of the gear wheel; and,
c. at least one pawl provided on the nut sleeve wherein in a first position at least one portion of the at least one pawl engages at least a portion of the space between adjacent teeth.

2. The self-locking chuck of claim 1 further comprising two pawls provided on the nut sleeve.

3. The self-locking chuck of claim 1 wherein the pawl has a v-shaped bend.

4. The self locking chuck of claim 3 wherein the pawl is slightly convex.
